(19) United States
(12) Patent Application Publication
(10) Pub. No.: US 2017/0083282 A1
(43) Pub. Date: Mar. 23, 2017

(54) INFORMATION PROCESSING DEVICE, CONTROL METHOD, AND PROGRAM

(71) Applicant: SONY CORPORATION, TOKYO (JP)

(72) Inventor: TOMOHIRO TSUNODA, TOKYO (JP)

(21) Appl. No.: 15/311,381

(22) PCT Filed: Mar. 2, 2015
(86) PCT No.: PCT/JP2015/056109

§ 371 Date: Nov. 15, 2016

(30) Foreign Application Priority Data
Jun. 3, 2014 (JP) 2014-114771

(51) Int. Cl. G06F 3/16; G06K 9/00; H04N 7/18; H04N 5/33; G06F 21/84; H04R 1/10

(52) U.S. Cl. CPC G06F 3/165; G06F 21/84; H04R 1/1091; H04N 7/183; H04N 5/33; G06K 9/00771

(57) ABSTRACT

[Object] To provide an information processing device, a control method, and a program that can perform more optimal information presentation in accordance with user condition and surrounding environment.

[Solution] Provided is an information processing device including: a user condition recognition unit configured to recognize user condition on the basis of sensing data obtained by detecting condition of a user; an environment recognition unit configured to recognize surrounding environment on the basis of sensing data obtained by detecting surrounding environment of the user; and a presentation control unit configured to perform control such that information presentation to the user is performed on the basis of an information presentation rule that depends on the recognized user condition and surrounding environment.

### CROSS REFERENCE RELATED APPLICATIONS

This application is a U.S. National Phase of International Patent Application No. PCT/JP2015/056109 filed on Mar. 2, 2015, which claims priority benefit of Japanese Patent Application No. JP 2014-114771 filed in the Japan Patent Office on Jun. 3, 2014. Each of the above-referenced applications is hereby incorporated herein by reference in its entirety.

### TECHNICAL FIELD

The present disclosure relates to an information processing device, a control method, and a program.

### BACKGROUND ART

Conventionally, the sound volume control has been made manually by the user in various devices for outputting sound. Devices for outputting sound include, for example, stereo speakers, wireless speakers, music players, portable gaming machines, television receivers (TV), personal computers (PC), and the like.

For such sound volume control of output devices, a technique is proposed in Patent Literature 1 below, for example, which analyzes surrounding condition on the basis of ambient sound (environmental sound) of an output device such as a television receiver (TV) and captured images from capturing the surroundings and controls sound output of the TV so that the sound of the TV program becomes clear for the user watching TV.

### CITATION LIST

### Patent Literature

Patent Literature 1: JP 2013-26997A

### SUMMARY OF INVENTION

### Technical Problem

Here, in recent years, a headphone speaker device has been proposed which is provided with speakers that have outward directivity at left and right slider parts of a pair of overhead type headphones that seal the ears. A user can wear such headphone speaker device around the neck to listen to the sound from the speakers without sealing the ears and with the sound of the surroundings audible. As such, it can be used safely while walking outside, running, or even riding a bike, since the sound from the speakers is audible with the sound of the surroundings audible.

However, when the headphone speaker device is worn around the neck to be used as a pair of speakers, there has been a possibility that the sound outputted from the headphone speaker device being heard by others in the vicinity. The user has been required to reduce the sound volume manually when there is any person in the vicinity, because it is conceived that information which is audio outputted from the headphone speaker device is not limited to music and that, for example, by wirelessly connecting with a smartphone carried by the user, private information such as an e-mail notification, an e-mail content, or a voice call received by the smartphone is also outputted.

Accordingly, the present disclosure proposes an information processing device, a control method, and a program that can perform more optimal information presentation in accordance with user condition and surrounding environment.

### Solution to Problem

According to the present disclosure, there is provided an information processing device including: a user condition recognition unit configured to recognize user condition on the basis of sensing data obtained by detecting condition of a user; an environment recognition unit configured to recognize surrounding environment on the basis of sensing data obtained by detecting surrounding environment of the user; and a presentation control unit configured to perform control such that information presentation to the user is performed on the basis of an information presentation rule that depends on the recognized user condition and surrounding environment.

According to the present disclosure, there is provided a control method including: recognizing user condition on the basis of sensing data obtained by detecting condition of a user; recognizing surrounding environment on the basis of sensing data obtained by detecting surrounding environment of the user; and performing control such that information presentation to the user is performed on the basis of an information presentation rule that depends on the recognized user condition and surrounding environment.

According to the present disclosure, there is provided a program for causing a computer function as: a user condition recognition unit configured to recognize user condition on the basis of sensing data obtained by detecting condition of a user; an environment recognition unit configured to recognize surrounding environment on the basis of sensing data obtained by detecting surrounding environment of the user; and a presentation control unit configured to perform control such that information presentation to the user is performed on the basis of an information presentation rule that depends on the recognized user condition and surrounding environment.

### Advantageous Effects of Invention

As described above, the present disclosure allows more optimal information presentation to be performed in accordance with user condition and surrounding environment.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 illustrates an overview of a control system according to an embodiment of the present disclosure.

FIG. 2 is a diagram illustrating one example of an internal configuration of a control server according to the present embodiment.

FIG. 3 is a sequence diagram illustrating a first information presentation control process according to the present embodiment.

FIG. 4 is a sequence diagram illustrating a second information presentation control process according to the present embodiment.

FIG. 5 is a sequence diagram illustrating a rule modification process according to the present embodiment.

FIG. 6 is a block diagram illustrating one example of a hardware configuration of an information processing device capable of realizing a control server according to the present embodiment.

### DESCRIPTION OF EMBODIMENT(S)

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Additionally, the description will be made in the following order.
1. Overview of a control system according to an embodiment of the present disclosure
2. Basic configuration
3. Operation process
3-1. First information presentation control process
3-2. Second information presentation control process
3-3. Rule modification process
4. Summary

<1. Overview of a Control System According to an Embodiment of the Present Disclosure>

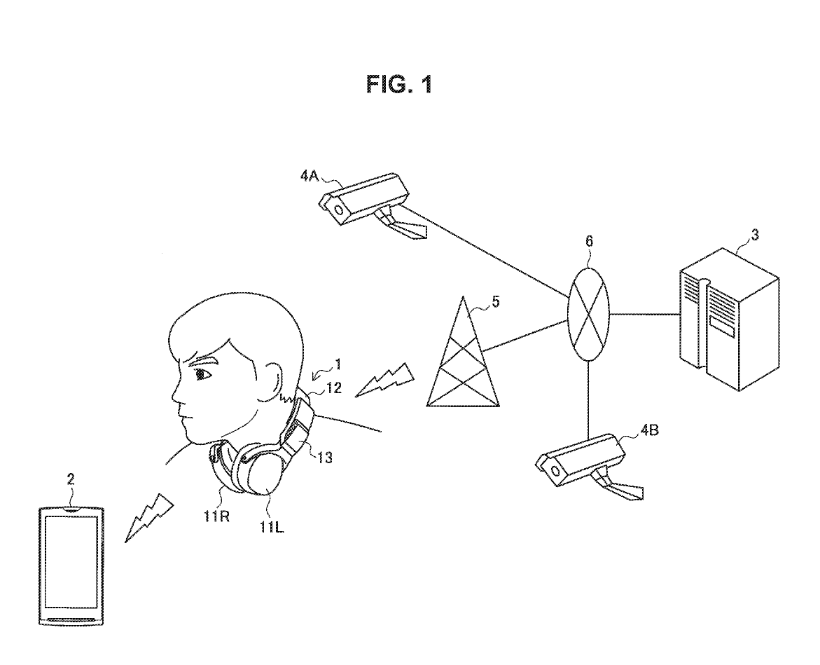

First, an overview of a control system according to an embodiment of the present disclosure is illustrated in FIG. 1 and described. As shown in FIG. 1, a control system according to the present embodiment includes a headphone speaker device 1 which is one example of a user device, fixed cameras 4A, 4B which are one example of an external sensor, and a control server 3.

The headphone speaker device 1 according to the present embodiment is an overhead closed-back stereo headphone device, for example, which is provided with a left housing 11L and a right housing 11R that are worn on the left and right ear parts of a user, respectively, at the ends of a headband 12. Further, the headphone speaker device 1 is provided with speakers 13 that have outward directivity at left and right slider parts, so that it is also possible to listen to sound outputted from the speakers 13 with the headphone speaker device 1 worn around the neck as shown in FIG. 1. This enables the user to enjoy music reproduced from the speakers 13 of the headphone speaker device 1 with the sound of the surroundings audible while walking, running, riding a bike, or the like.

Further, the headphone speaker device 1 according to the present embodiment can audio output not only data stored in an internal memory but also data received from an external device through wireless connection with the external device. For example, through wireless connection with a smartphone 2 as shown in FIG. 1, the headphone speaker device 1 can audio output a newly arrived e-mail information, an e-mail content, an incoming phone call information, or the like.

Here, if the newly arrived e-mail information, the e-mail content, or the like audio outputted from the speakers 13 with the headphone speaker device 1 worn around the neck, the user has been required to ascertain whether there is any person in the vicinity or not to adjust the sound volume manually since there has been a possibility that such private information being heard by the person in the vicinity.

Accordingly, the present embodiment allows user condition and surrounding environment of the user to be recognized and optimal information presentation control to be performed on the headphone speaker device 1 in accordance with an information presentation rule that depends on the recognized user condition and user surrounding environment of the user. Specifically, the control server 3 recognizes the user condition and surrounding environment on the basis of sensing data acquired by a sensor built into the user device (e.g., a camera, a human detection sensor such as an infrared sensor, a location sensor, an accelerometer, or a geomagnetic sensor provided in the headphone speaker device 1), or sensing data acquired by an external sensor (e.g., the fixed cameras 4A, 4B, or an infrared sensor, a microphone, an illuminance sensor, or the like). The headphone speaker device 1 can connect to a network 6 via a base station 5 and perform transmission and reception of data to and from the control server 3 on the network 6, as shown in FIG. 1. Further, although there are two fixed cameras 4A, 4B shown in FIG. 1, the present embodiment is not so limited, and there may be one or more fixed cameras, for example. Further, the fixed camera 4 may be installed outdoors/indoors, and the control server 3 may acquire the sensing data from the fixed camera 4 installed in the surroundings of the user on the basis of information of the current location acquired by the headphone speaker device 1, for example.

The control server 3 then selects the information presentation rule that depends on the recognized user condition and surrounding environment and controls audio output from the headphone speaker device 1 in accordance with the selected information presentation rule. This enables the user to automatically have optimal information presentation without manually adjusting the sound volume of the headphone speaker device 1.

As described above, the control system according to the present embodiment allows optimal information presentation control to be performed in accordance with the information presentation rule that depends on the user condition and surrounding environment. Note that the sensor built into the user device described above is not limited to various sensors provided in the headphone speaker device 1 and may, for example, be a location sensor, an accelerometer, a geomagnetic sensor, a microphone, or the like provided in the smartphone 2 carried by the user. The smartphone 2 transmits the acquired sensing data to the control server 3 via the network 6.

Further, in the present embodiment, although, by the control server 3, the information presentation control is performed on the headphone speaker device 1 which is provided with the speakers that have outward directivity, this is merely an example, and the information presentation control may be performed on the other user device, as well. Specifically, it may be performed on a wearable device, such as a spectacle-type head mounted display (HMD) or a wristwatch-type device, a portable gaming machine, a television receiver (TV), a tablet terminal, a PC, or the like provided with the speakers that have outward directivity.

Further, the information presentation control is not limited to control of the information presentation by audio output from the user device, and may, for example, be control of the information presentation by display output from the user device. Specifically, for example, when connecting an information processing device, such as a note PC or a tablet terminal to an external display device (also including projectors) and externally outputting screen information for browsing by a plurality of persons, displaying a pop-up notification of a newly arrived e-mail or the like as usual causes the private information to be seen by people other than the user. Accordingly, the control server 3 also performs the information presentation control for display output from the user device in accordance with the information presentation rule that depends on the user condition and surrounding environment, so that the user can have more optimal information presentation.

The control system according to an embodiment of the present disclosure has been described above. Secondly, a basic configuration of the control server 3 included in the control system of the present embodiment is described.

<2. Basic Configuration>

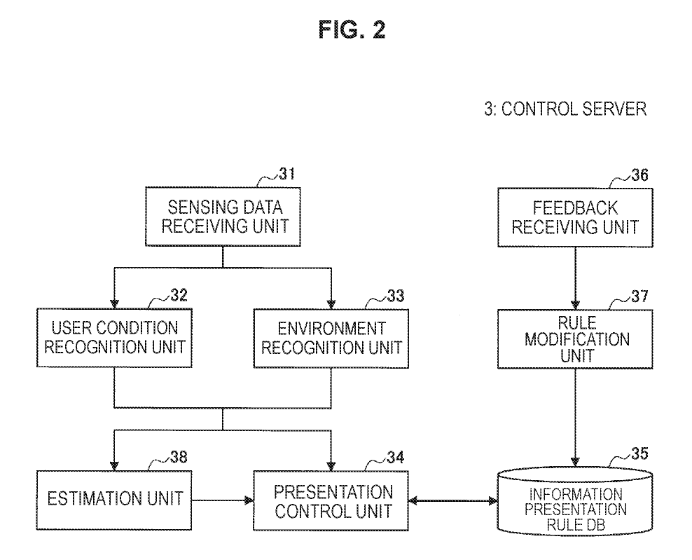

FIG. 2 is a diagram illustrating one example of an internal configuration of the control server 3 according to the present embodiment. As shown in FIG. 2, the control server 3 includes a sensing data receiving unit 31, a user condition recognition unit 32, an environment recognition unit 33, a presentation control unit 34, an information presentation rule database (DB) 35, a feedback receiving unit 36, a rule modification unit 37, and an estimation unit 38.

(2-1. Sensing Data Receiving Unit 31)

The sensing data receiving unit 31 acquires sensing data acquired by the sensor built into the user device or the external sensor. For example, the sensing data receiving unit 31 receives data from detection by various sensors provided in the headphone speaker device 1 or a captured image captured by the fixed cameras 4A, 4B via the network 6. Here, the headphone speaker device 1 according to the present embodiment may be provided with various sensors such as an image sensor (camera), an infrared sensor, an accelerometer, a geomagnetic sensor, or a location sensor. The image sensor (camera) can be provided, for example, in the headband 12 of the headphone speaker device 1 facing outward, thereby allowing the user to capture an image of the surroundings of the user while wearing the headphone speaker device 1 around the neck. Further, an accelerometer, a geomagnetic sensor, a location sensor, or the like provided in the headphone speaker device 1 can detect the current location or moving status of the user.

The sensing data receiving unit 31 outputs the received sensing data to respective one of the user condition recognition unit 32 and the environment recognition unit 33.

(2-2. User Condition Recognition Unit 32)

The user condition recognition unit 32 recognizes the user condition on the basis of the sensing data by the built-in sensor or the external sensor. More specifically, the user condition recognition unit 32 recognizes at least any one of the current location, the moving status, and an accompanying person of the user as the user condition. For example, the user condition recognition unit 32 recognizes the current location of the user on the basis of the sensing data acquired by a location sensor built into the headphone speaker device 1, and recognizes things like whether the user is in the user's home or office in the case that the user's home or office is known.

Further, the user condition recognition unit 32 recognizes the moving status of the user such as whether the user is walking, riding a bike, or on the train on the basis of the sensing data acquired by a location sensor, an accelerometer, a geomagnetic sensor, or the like built into the headphone speaker device 1.

Further, the user condition recognition unit 32 can recognize whether the user is alone or with someone else (and in the latter case, who is the accompanying person of the user), or the like on the basis of the captured image captured by the camera provided in the headphone speaker device 1 or the sound picked up by a microphone. Further, the user condition recognition unit 32 can recognize the current location of the user on the basis of the sensing data acquired by the location sensor built into the headphone speaker device 1 and can refer to information that indicates whether the location is clouded or not, or the like to recognize whether the user is alone or not.

(2-3. Environment Recognition Unit 33)

The environment recognition unit 33 recognizes the surrounding environment of the user on the basis of the sensing data by the built-in sensor or the external sensor. More specifically, the environment recognition unit 33 recognizes a person around the user or behavior of the person, whether there is anyone approaching the user or not, or the like as the surrounding environment. For example, the environment recognition unit 33 can recognize the person around the user or the person approaching the user on the basis of the captured image captured by the fixed cameras 4A, 4B.

(2-4. Presentation Control Unit 34)

The presentation control unit 34 selects the information presentation rule from the information presentation rule DB 35 that depends on the user condition and surrounding environment and performs predetermined information presentation control on the headphone speaker device 1 in accordance with the selected information presentation rule. More specifically, the presentation control unit 34 transmits a control signal for performing control (configuration) of propriety of the presentation of information from the headphone speaker device 1, a type of information to present, and an output parameter when presenting to the headphone speaker device 1 (which is one example of the user device).

For example, when each recognition result by the user condition recognition unit 32 and the environment recognition unit 33 shows that “the user is currently alone,” the presentation control unit 34 selects the information presentation rule that is associated with the case that the user is alone. In such information presentation rule, it is defined, for example, to control so that the presentation of general information and the private information is approved, and these are presented with the sound volume “high.”

On the other hand, when each recognition result of the user condition recognition unit 32 and the environment recognition unit 33 shows that “there is a person in the vicinity of the user,” the presentation control unit 34 selects the information presentation rule that is associated with the case that there is a person in the vicinity of the user. In such information presentation rule, it is defined, for example, to control so that the presentation of the private information is disapproved, and the presentation of the general information is approved while the sound volume is at “low.”

In the example as described above, although the presentation control unit 34 selects the information presentation rule associated with the current condition and the current surrounding environment of the user recognized by the user condition recognition unit 32 and the environment recognition unit 33, the present embodiment is not so limited. For example, when a change in the user condition and surrounding environment is estimated by the estimation unit 38, the presentation control unit 34 may select the information presentation rule that depends on estimation result.

More specifically, for example, even when it is recognized that “there is no person in the vicinity of the user” in the user current condition and the current surrounding environment, if it is estimated, by the estimation unit 38, that “there is (there will be an appearance of) a person in the vicinity of the user,” the presentation control unit 34 selects the information presentation rule associated with the case that there is a person in the vicinity of the user. In such information presentation rule, it is defined, for example, to control so that the presentation of the private information is gradually faded out and turned off, and, for the presentation of the general information, the sound volume is adjusted from “high” to “low.” This enables preventing the private information from being heard by performing the presentation control “when there is a person in the vicinity of the user” depending on estimation result even when a bicycle is approaching from behind the user, or a person suddenly appears from the place the user cannot see (the blind spots), for example.

(2-5. Estimation Unit 38)

The estimation unit 38 estimates a change in the user condition and surrounding environment on the basis of the sensing data by the built-in sensor or the external sensor. More specifically, the estimation unit 38 recognizes whether anyone appears in the vicinity of the user or not as the change in the user condition and surrounding environment. For example, the estimation unit 38 recognizes a direction of movement of a person around and estimates whether the person appears in the vicinity of the user or not on the basis of the captured image captured by the fixed cameras 4A, 4B installed in the surroundings of the user (e.g., a predetermined range centered at the current location of the user).

(2-6. Information Presentation Rule DB 35)

The information presentation rule DB 35 is a memory unit which stores the information presentation rule that depends on the user condition and surrounding environment. In the information presentation rule, propriety of the presentation of the information, a type of information to present (e.g., the private information or the general information), and an output parameter when presenting, or the like is defined depending on whether the user is alone, where the user is, what is the moving status of the user, or with who the user is (who is the accompanying person), or the like.

Specifically, as described above, a rule is defined to control output with the sound volume “high” for both of the private information and the general information when “there is no person in the vicinity of the user,” and a rule is defined to disapprove the presentation for the private information and to control output with the sound volume “low” for the general information when “there is a person in the vicinity of the user,” for example.

Further, in addition to whether the user is alone or not, a rule may be defined that depends on places/conditions (moving status, with who the user is, etc.)/time slots. For example, even when “there is a person in the vicinity of the user,” if it is the case that “the user is in the user's home,” or that “the accompanying person is one of the user's family,” a rule may be defined to control output with the sound volume “high” for both of the private information and the general information. Further, when “there is a person in the vicinity of the user,” “in the time slot of weekday morning,” and the user is “on the train,” it is estimated that the train is crowded, and therefore, a rule may be defined in which both of the private information and the general information are disapproved to audio output.

(2-7. Feedback Receiving Unit 36)

The feedback receiving unit 36 receives information of an operation inputted by the user (specifically, a modification operation related to the information presentation control) from the headphone speaker device 1 as feedback after the presentation control unit 34 automatically performed the information presentation control of the headphone speaker device 1. The feedback receiving unit 36 outputs the received feedback information to the rule modification unit 37.

(2-8. Rule Modification Unit 37)

The rule modification unit 37 personalizes the information presentation rule stored in the information presentation rule DB 35 on the basis of the feedback information. More specifically, the rule modification unit 37 newly generates an information presentation rule tailored to the target user and registers the information presentation rule to the information presentation rule DB 35.

For example, the rule modification is described when the information presentation rule is predefined so that both of the private information and the general information are outputted with the sound volume “high” even when “there is a person in the vicinity of the user,” if it is the case that “the user is in the user's home. In this case, in the headphone speaker device 1, both of the private information and the general information are audio outputted with the sound volume “high.” However, some user may not wish the private information to be heard by anyone of the user's family and may perform a stopping operation when the private information is audio outputted. In turn, the headphone speaker device 1 transmits information of the stopping operation performed by the user to the control server 3 as feedback. Then, on the basis of such feedback, the rule modification unit 37 of the control server 3 newly generates a rule to disapprove the presentation for the private information and to control output with the sound volume “high” for the general information when “there is a person in the vicinity of the user,” and it is the case that “the user is in the user's home” and registers the rule to the information presentation rule DB 35 with the rule associated with the user.

The configuration of the control server 3 according to the present embodiment has been specifically described above. Note that the configuration of the control server 3 shown in FIG. 2 is merely one example, the present disclosure is not so limited, and the configuration of part of the control server 3 may be provided in the external device, for example. Specifically, the user condition recognition unit 32 and the environment recognition unit 33 shown in FIG. 2 may be provided in the user device, the fixed camera, or the like. In this case, the user device, the fixed camera, or the like recognizes the user condition and surrounding environment on the basis of the detected sensing data and transmits the recognized result to the control server 3.

<3. Operation Process>

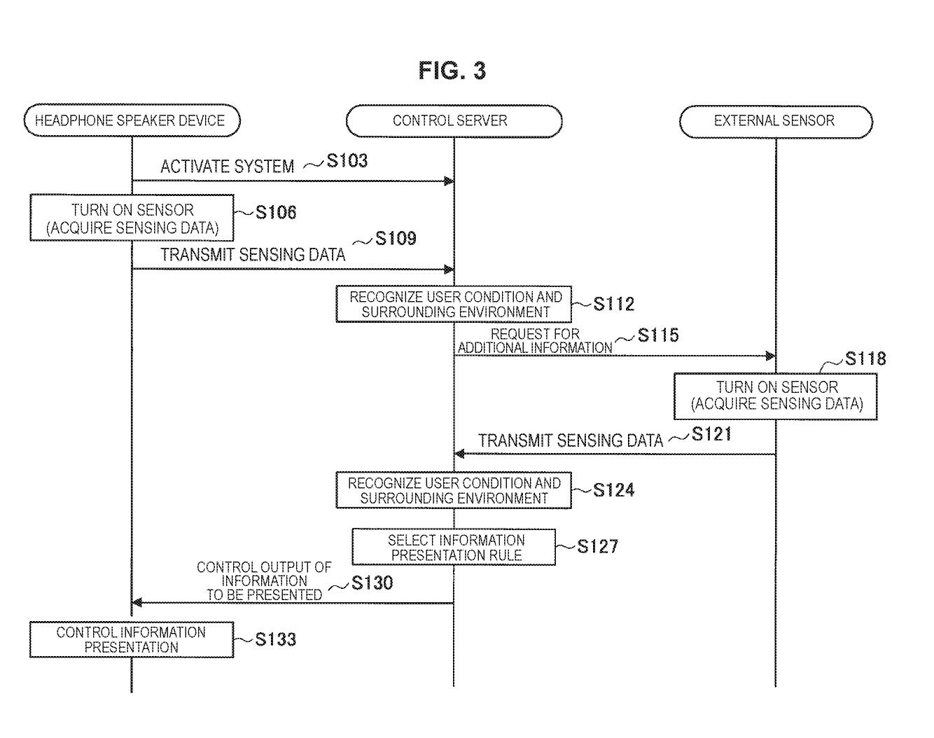

Thirdly, the operation process of the control system according to the present embodiment is described with reference to FIG. 3 through FIG. 5.

(3-1. First Information Presentation Control Process)

FIG. 3 is a sequence diagram illustrating a first information presentation control process according to the present embodiment. As shown in FIG. 3, first, in step S103, the headphone speaker device 1 notifies the control server 3 to activate the system actively as appropriate. Activation of the system is triggered when the headphone speaker device 1 is worn around the neck, and the audio output (music reproduction, etc.) is started by the speakers 13 that have outward directivity provided in the headphone speaker device 1, for example. Further, it may be triggered when the headphone speaker device 1 received various notifications such as newly arrived e-mail notification, incoming phone call notification, or newly arrived news information from the smartphone 2.

Next, in step S106, the headphone speaker device 1 turns the built-in sensor ON and acquires the sensing data. Specifically, the headphone speaker device 1 captures the surroundings (a person in the vicinity) of the user by a camera (an image sensor) to acquire the captured image, to acquire the current location with a location sensor, or to detect the motion of the user by an accelerometer and a geomagnetic sensor.

Then, in step S109, the headphone speaker device 1 transmits the acquired sensing data to the control server 3 via the network 6.

Subsequently, in step S112, the user condition recognition unit 32 and the environment recognition unit 33 of the control server 3 performs recognition of the user condition and surrounding environment, respectively, on the basis of sensing data received from the headphone speaker device 1 by the sensing data receiving unit 31.

Next, in step S115, the control server 3 performs inquiry for additional information (additional sensing data) to the other sensor as appropriate. Here, the inquiry to the external sensor is performed since the sensing data from the built-in sensor of the user device (specifically, the sensor provided in the headphone speaker device 1) is successfully acquired. The external sensor includes, for example, the fixed cameras 4A, 4B shown in FIG. 1 installed in the surroundings of the user, an infrared sensor, a microphone, an illuminance sensor, or the like.

Next, in step S118, the external sensor turns the sensor ON and acquires the sensing data. Specifically, when the external sensor is a fixed camera 4, for example, the captured image from capturing the surroundings is acquired as the sensing data.

Next, in step S121, the external sensor transmits the acquired sensing data to the control server 3 via the network 6.

Subsequently, in step S124, the user condition recognition unit 32 and the environment recognition unit 33 of the control server 3 recognizes the user condition and surrounding environment more accurately on the basis of the additional sensing data.

Then, in step S127, the presentation control unit 34 of the control server 3 selects an information presentation rule from the information presentation rule DB 35 that depends on the user condition and surrounding environment recognized by the user condition recognition unit 32 and the environment recognition unit 33, respectively.

Next, in step S130, the presentation control unit 34 of the control server 3 transmits a control signal for performing control of output of the information to be presented in accordance with the selected information presentation rule to the headphone speaker device 1 that performs information presentation to the user.

Then, in step S133, the headphone speaker device 1 performs controlling of the audio output from the speakers 13 on the basis of control of output of the information to be presented from the control server 3.

Thus, when the user is wearing the headphone speaker device 1 around the neck and listening to music with the speakers 13, the control server 3 controls output with the sound volume “high” when there is no person in the vicinity and controls output with the sound volume “low” when there is a person in the vicinity in accordance with the defined information presentation rule. Further, when receiving the private information such as e-mail notification information or incoming phone call information from the smartphone 2 to output from the speakers 13 of the headphone speaker device 1, the control server 3 controls output with the sound volume “high” when there is no person in the vicinity, and stops output when there is a person in accordance with the defined information presentation rule. Furthermore, the information presentation rule that depends on where currently the user is (in the user's home or out), or what is the moving status (on foot, on the bike, on the train, etc.) may be defined. This enables the control server 3 to control output with the sound volume “high” for the information to be presented in accordance with the defined information presentation rule even when there is a person in the vicinity of the user, if it is the case that the user is in the user's home, for example.

The first information presentation control process described with reference to FIG. 3 has been described above. By repeating steps S106-S133 described above while the system is activated, suitable information presentation control in accordance with the user condition or surrounding environment is performed automatically without the user manually adjusting the sound volume.

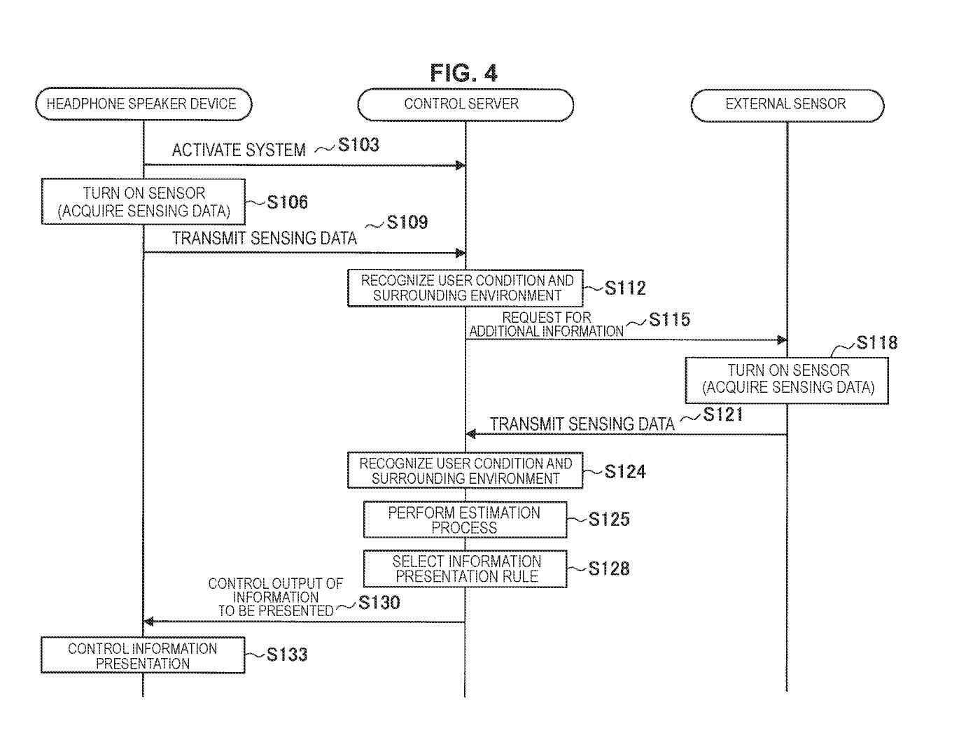

Further, in the first information presentation control process, although the information presentation control is performed in accordance with the current user condition and surrounding environment recognized in real-time, the present disclosure is not so limited, and it is possible to estimate an appearance of a person in the vicinity of the user and to perform the information presentation control on the basis of estimation result, for example. FIG. 4 is referred to and described below as a second information presentation control process.

(3-2. Second Information Presentation Control Process)

FIG. 4 is a sequence diagram illustrating a second information presentation control process. In steps S103-S124 shown in FIG. 4, the similar process is performed as the same step shown in FIG. 3. Note that necessary information for an estimating process described below may be requested in the request for additional information (additional sensing data) shown in step S115. For example, the additional sensing data is required to the external sensor installed in roads or buildings in the predetermined range centered at the current location of the user.

Next, in step S125, the estimation unit 38 of the control server 3 estimates a change in the user condition and surrounding environment on the basis of the current user condition and surrounding environment recognized by the user condition recognition unit 32 and the environment recognition unit 33, respectively. For example, the estimation unit 38 estimates whether anyone appears in the vicinity of the user or not.

Then, in step S128, the presentation control unit 34 of the control server 3 selects an information presentation rule from the information presentation rule DB 35 that depends on the estimated result (the user condition and surrounding environment) estimated by the estimation unit 38. For example, even if currently there is no person in the vicinity of the user, if it is estimated, by the estimation unit 38, that there will be an appearance of a person in the vicinity of the user (if an appearance from around the corner or an appearance from behind/in front by bike is estimated), the presentation control unit 34 selects the information presentation rule associated with the case that there is a person in the vicinity of the user.

Next, in step S130, the presentation control unit 34 of the control server 3 transmits a control signal for performing control of output of the information to be presented in accordance with the selected information presentation rule to the headphone speaker device 1 that performs information presentation to the user.

Then, in step S133, the headphone speaker device 1 performs controlling of the audio output from the speakers 13 in accordance with control of output of the information to be presented from the control server 3.

This enables a more suitable presentation control to be performed by pre-selecting the information presentation rule that depends on the estimated result even when currently there is no person in the vicinity of the user, if it is estimated that a person appears from around the corner, from behind/in front by bike, or enter the room from outside. In other words, it is possible to prevent the information presented to the user from being heard or seen by the person suddenly appeared in the vicinity.

(3-3. Rule Modification Process)

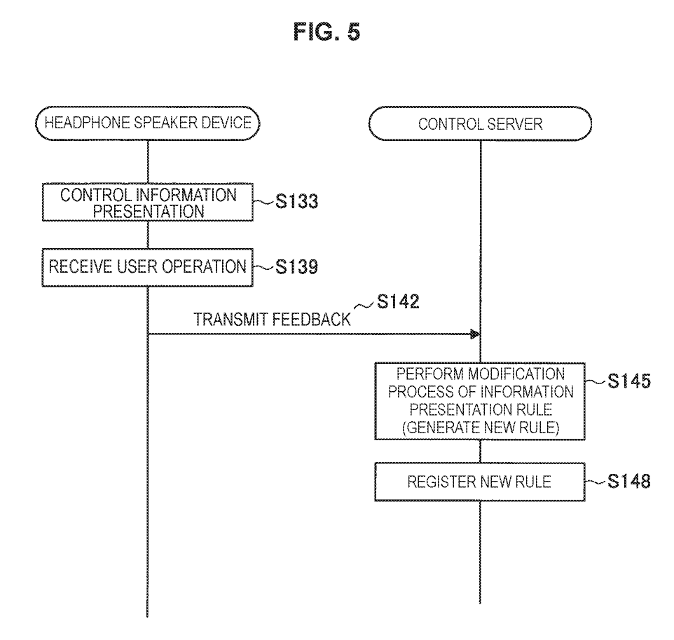

Subsequently, the process when modifying the information presentation rule to be tailored to an individual according to the present embodiment is described with reference to FIG. 5. FIG. 5 is a sequence diagram illustrating a rule modification process according to the present embodiment.

As shown in FIG. 5, first, in step S133, the headphone speaker device 1 performs controlling of the audio output from the speakers 13 in accordance with the control of output of the information to be presented from the control server 3 as described in FIGS. 3 and 4. At this time, the user can manually perform a modification operation to the automatically controlled audio output. For example, when the person in the vicinity (the accompanying person) of the user is one of the user's family, output for the private information is also automatically controlled with the sound volume “high” in accordance with the predefined information presentation rule, however, some user may not prefer such control and may not wish the private information to be heard by any one of user's family. In this case, the user is to manually perform an operation for stopping output or an operation for turning down the sound volume (e.g., an operation with the sound volume button (not shown) provided with the headphone speaker device 1) after the sound volume automatically controlled to be “high.”

Next, upon receiving a user operation under the circumstances described above in step S139, the headphone speaker device 1 transmits information of the user operation to the control server 3 as feedback information in the next step S142.

Then, in step S145, the rule modification unit 37 of the control server 3 performs modification process of the information presentation rule stored in the information presentation rule DB 35 on the basis of the feedback information received from the headphone speaker device 1 by the feedback receiving unit 36. In other words, the rule modification unit 37 newly generates an information presentation rule that corresponds to the current user condition and surrounding environment from the output control content (such as propriety of the presentation, a type of information to present, and an output parameter) indicated by the received feedback information.

Then, in step S148, the rule modification unit 37 registers the content of modification into the information presentation rule DB 35. In other words, the rule modification unit 37 associates the newly generated information presentation rule on the basis of the feedback information with the target user to store in the information presentation rule DB 35.

As described above, the control system according to the present embodiment can modify the information presentation rule to be tailored to each user.

(Information Processing Device According to the Present Embodiment)

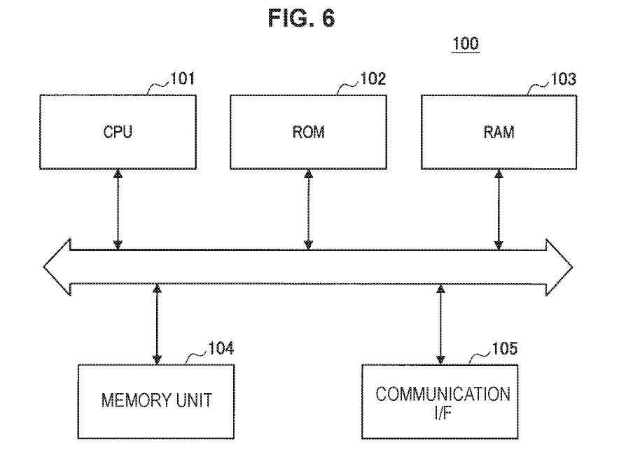

The control system according to the present embodiment has been specifically described above. Here, a hardware configuration of the control server 3 included in the control system described above is described with reference to FIG. 6. In FIG. 6, one example of a hardware configuration of an information processing device 100 capable of realizing a control server 3 is illustrated.

As shown in FIG. 6, the information processing device 100 includes, for example, a central processing unit (CPU) 101, a read only memory (ROM) 102, a random access memory (RAM) 103, a memory unit 104, and a communication interface (I/F) 105. Further, the information processing device 100, for example, connects components with each other with a bus as a data transmission line.

CPU 101 is configured, for example, with microcomputer and controls each configuration of the information processing device 100. Further, CPU 101 functions as the user condition recognition unit 32, the environment recognition unit 33, the presentation control unit 34, the rule modification unit 37, and the estimation unit 38 in the control server 3.

ROM 102 stores a program used by CPU 101, control data such as operation parameters, and the like. RAM 103 temporarily stores, for example, a program to be executed by CPU 101, and the like.

The memory unit 104 stores various data. For example, the memory unit 104 serves as the information presentation rule DB 35 in the control server 3.

The communication I/F 105 is a communication means with which the information processing device 100 is provided and communicates with an external device involved in the control system according to the present embodiment via a network (or directly). For example, the communication I/F 105 performs transmission and reception of data to and from the headphone speaker device 1 or the fixed cameras 4A, 4B via network 6 in the control server 3. Further, the communication I/F 105 functions as the sensing data receiving unit 31, the feedback receiving unit 36, and the presentation control unit 34 in the control server 3.

One example of the hardware configuration of the information processing device 100 according to the present embodiment has been described above.

<4. Summary>

As described above, the control system according to embodiments of the present disclosure allows suitable information presentation control to be performed to the user in accordance with the information presentation rule that depends on the user condition and surrounding environment. Specifically, for example, the output device for presenting information to the user (e.g., the headphone speaker device 1) is controlled so that the information presentation is performed with the sound volume “high” when there is no person in the vicinity of the user, and the information presentation is performed with the sound volume of “low” when there is a person in the vicinity of the user.

Further, the control system according to the present embodiment can estimate a change in the user condition and surrounding environment and can perform a suitable information presentation control to the user in accordance with the information presentation rule that depends on the estimated result (the estimated user condition and surrounding environment). Specifically, for example, even when currently there is no person in the vicinity of the user, if it is estimated that there will be an appearance of a person, it is controlled so that the information presentation rule associated with the case that there is a person in the vicinity of the user is applied, and the information presentation is performed with the sound volume “low.” This enables avoiding the information presented from being heard or seen by the person suddenly appeared by applying the information presentation rule associated with the case that there is a person in the vicinity of the user beforehand even when suddenly a person appears from around the corner, from behind by bike, or enter the room from outside.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, for hardware such as CPU, ROM, and RAM built into the control server 3 and the headphone speaker device 1 described above, a computer program to bring out the functions of the control server 3 and the headphone speaker device 1 can be created. Further, a computer-readable storage medium is also provided which stores the computer program.

Further, although the control server 3 on the network performs control of output of the information to be presented on the headphone speaker device 1 in the embodiment described above, the present disclosure is not so limited. The configuration of the control server 3 shown in FIG. 2 may be provided in the headphone speaker device 1 so that the headphone speaker device 1 itself performs the control of output of the information to be presented according to the present embodiment, for example.

Further, various context information such as schedule information, time, or day of the week of the user can be utilized when the user condition recognition unit 32 described above identifies the person in the vicinity (accompanying person) of the user or recognizes how the user is currently moving (on foot, on bike, on train, etc.) as the user condition.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also be configured as below.
(1)

An information processing device including:

a user condition recognition unit configured to recognize user condition on the basis of sensing data obtained by detecting condition of a user;

an environment recognition unit configured to recognize surrounding environment on the basis of sensing data obtained by detecting surrounding environment of the user; and

a presentation control unit configured to perform control such that information presentation to the user is performed on the basis of an information presentation rule that depends on the recognized user condition and surrounding environment.
(2)

The information processing device according to (1), further including:

an estimation unit configured to estimate a change in the condition and the surrounding environment of the user on the basis of at least any one of the recognized user condition and surrounding environment,

wherein the presentation control unit performs control of information presentation on the basis of an information presentation rule that depends on a result estimated by the estimation unit.
(3)

The information processing device according to (2), wherein the estimation unit estimates whether a person appears in the vicinity of the user or not as the change in the condition and the surrounding environment of the user.
(4)

The information processing device according to any one of (1) to (3), wherein the information presentation rule defines propriety of the presentation of the information, a type of information to be presented, and an output parameter at a time of presentation, in accordance with whether there is a person in the vicinity of the user or not.
(5)

The information processing device according to (4), wherein the type of information to be presented includes general information and private information.
(6)

The information processing device according to any one of (1) to (5), wherein the information presentation rule is personalized in accordance with feedback from the user.
(7)

The information processing device according to (1), wherein the user condition recognition unit recognizes at least any one of a current location, a moving status, and an accompanying person of the user as the user condition.
(8)

The information processing device according to (7), wherein the information presentation rule is defined depending on whether the user is alone, where the user is, what moving status the user is in, or with who the user is.
(9)

The information processing device according to any one of (1) to (8), wherein the sensing data from detection of the condition of the user is acquired by a sensor provided in a wearable device carried by the user.
(10)

The information processing device according to any one of (1) to (4), wherein the environment recognition unit recognizes presence or absence of a person around the user or person approaching the user as the surrounding environment.
(11)

The information processing device according to any one of (1) to (10), wherein the sensing data obtained by detecting the surrounding environment of the user is acquired by a fixed camera or an infrared sensor installed indoors or outdoors.
(12)

The information processing device according to any one of (1) to (11), wherein the presentation control unit performs control such that information is presented to the user by audio output or display output.
(13)

The information processing device according to any one of (1) to (12), wherein the presentation control unit transmits a control signal to a user device to perform the information presentation in accordance with the information presentation rule.
(14)

A control method including:

recognizing user condition on the basis of sensing data obtained by detecting condition of a user;

recognizing surrounding environment on the basis of sensing data obtained by detecting surrounding environment of the user; and

performing control such that information presentation to the user is performed on the basis of an information presentation rule that depends on the recognized user condition and surrounding environment.
(15)

A program for causing a computer function as:

a user condition recognition unit configured to recognize user condition on the basis of sensing data obtained by detecting condition of a user;

an environment recognition unit configured to recognize surrounding environment on the basis of sensing data obtained by detecting surrounding environment of the user; and

a presentation control unit configured to perform control such that information presentation to the user is performed on the basis of an information presentation rule that depends on the recognized user condition and surrounding environment.

### REFERENCE SIGNS LIST

1 headphone speaker device
11L left housing
11R right housing
12 headband
13 speaker
2 smartphone
3 control server
31 sensing data receiving unit
32 user condition recognition unit
33 environment recognition unit
34 presentation control unit
35 information presentation rule DB
36 feedback receiving unit
37 rule modification unit
38 estimation unit
4, 4A, 4B fixed camera
5 base station
6 network

1. An information processing device comprising:
a user condition recognition unit configured to recognize user condition on the basis of sensing data obtained by detecting condition of a user;
an environment recognition unit configured to recognize surrounding environment on the basis of sensing data obtained by detecting surrounding environment of the user; and
a presentation control unit configured to perform control such that information presentation to the user is performed on the basis of an information presentation rule that depends on the recognized user condition and surrounding environment.

2. The information processing device according to claim 1, further comprising:
an estimation unit configured to estimate a change in the condition and the surrounding environment of the user on the basis of at least any one of the recognized user condition and surrounding environment,
wherein the presentation control unit performs control of information presentation on the basis of an information presentation rule that depends on a result estimated by the estimation unit.

3. The information processing device according to claim 2, wherein the estimation unit estimates whether a person appears in the vicinity of the user or not as the change in the condition and the surrounding environment of the user.

4. The information processing device according to claim 1, wherein the information presentation rule defines propriety of the presentation of the information, a type of information to be presented, and an output parameter at a time of presentation, in accordance with whether there is a person in the vicinity of the user or not.

5. The information processing device according to claim 4, wherein the type of information to be presented includes general information and private information.

6. The information processing device according to claim 1, wherein the information presentation rule is personalized in accordance with feedback from the user.

7. The information processing device according to claim 1, wherein the user condition recognition unit recognizes at least any one of a current location, a moving status, and an accompanying person of the user as the user condition.

8. The information processing device according to claim 7, wherein the information presentation rule is defined depending on whether the user is alone, where the user is, what moving status the user is in, or with who the user is.

9. The information processing device according to claim 1, wherein the sensing data from detection of the condition of the user is acquired by a sensor provided in a wearable device carried by the user.

10. The information processing device according to claim 1, wherein the environment recognition unit recognizes presence or absence of a person around the user or person approaching the user as the surrounding environment.

11. The information processing device according to claim 1, wherein the sensing data obtained by detecting the surrounding environment of the user is acquired by a fixed camera or an infrared sensor installed indoors or outdoors.

12. The information processing device according to claim 1, wherein the presentation control unit performs control such that information is presented to the user by audio output or display output.

13. The information processing device according to claim 1, wherein the presentation control unit transmits a control signal to a user device to perform the information presentation in accordance with the information presentation rule.

14. A control method comprising:
recognizing user condition on the basis of sensing data obtained by detecting condition of a user;
recognizing surrounding environment on the basis of sensing data obtained by detecting surrounding environment of the user; and
performing control such that information presentation to the user is performed on the basis of an information presentation rule that depends on the recognized user condition and surrounding environment.

15. A program for causing a computer function as:
a user condition recognition unit configured to recognize user condition on the basis of sensing data obtained by detecting condition of a user;
an environment recognition unit configured to recognize surrounding environment on the basis of sensing data obtained by detecting surrounding environment of the user; and
a presentation control unit configured to perform control such that information presentation to the user is performed on the basis of an information presentation rule that depends on the recognized user condition and surrounding environment.
